(19) United States
(12) Patent Application Publication
(10) Pub. No.: US 2013/0236386 A1
(43) Pub. Date: Sep. 12, 2013

(54) COOLING AND/OR LUBRICATING FLUIDS FOR WAFER PRODUCTION

(71) Applicants: Hans-Peter Seelmann-Eggebert, Limburgerhof (DE); Sophie Maitro-Vogel, Mannheim (DE); Eva-Maria Reis-Walther, Breuberg (DE); Joachim Bentele, Lugwigshafen (DE); Lena Alveborn-Jansson, Hindas (SE)

(72) Inventors: Hans-Peter Seelmann-Eggebert, Limburgerhof (DE); Sophie Maitro-Vogel, Mannheim (DE); Eva-Maria Reis-Walther, Breuberg (DE); Joachim Bentele, Lugwigshafen (DE); Lena Alveborn-Jansson, Hindas (SE)

(21) Appl. No.: 13/751,995

(22) Filed: Jan. 28, 2013

Related U.S. Application Data
(60) Provisional application No. 61/593,329, filed on Feb. 1, 2012.

(51) Int. Cl. B28D 5/00

(52) U.S. Cl. CPC B28D 5/0076
USPC 423/348; 568/625; 568/624; 125/21

(57) ABSTRACT

The invention relates to the use of modified polyglycols for production of cooling and/or lubricating fluids, to novel cooling and/or lubricating fluids, to the use of the cooling and/or lubricating fluids in the removal of material, especially in the cutting of wafers, and to wafers produced with the aid of the cutting fluid.

### Description

The invention relates to the use of modified polyglycols for production of cooling and/or lubricating fluids, to novel cooling and/or lubricating fluids, to the use of the cooling and/or lubricating fluids in the removal of material, especially in the cutting of wafers, and to wafers produced with the aid of the cutting fluid.

Wafers are thin slices of semiconductors which are used, for example, in photovoltaics. Wafers can be used to produce electronic components, particularly integrated circuits. The wafers consist generally of brittle material, for example of silicon, but also of gallium arsenide or cadmium telluride, etc. The wafer production is generally based on cylindrical or cubic single crystals or polycrystals, which are sawn into the individual slices, the wafers. The sawing, also referred to as cutting or lapping, is effected in practice by wire sawing, employing essentially two processes.

What is called loose abrasive wafer cutting is a separation process using a thin wire as a cutter and using unbound cutting grains in a carrier fluid. The wire generally has a diameter of 80 to 180 μm. It is immersed into a slurry composed of carrier fluid and cutting grain and draws the cutting grains stuck to the wire surface into the saw gap. The cutting grains cut the article/silicon block—called ingot—to be sawn/lapped into wafers, removing particles from the solid to be cut. The carrier fluid for the cutting grains is applied as a slurry together with the cutting grain by means of an immersion bath through which the wire runs, and generally by means of nozzles. One task of the carrier fluid is to ensure the adhesion of the cutting grains on the wire and to move particles removed out of the solid to be divided. In addition, the carrier fluid has the task of ensuring cooling and the transport of the attritus through the saw slit.

In the second process, called fixed abrasive wafer cutting, wires set with diamonds and cooling fluids are used. The prior art specifies corresponding cooling fluids, which comprise water for reasons of cost and for better heat removal. The presence of water is technically disadvantageous per se, since the resultant silicon attritus reacts with water to give silicates, separates out and forms lumps. In order to avoid these disadvantages, corresponding aqueous coolants must comprise high proportions of glycols and additives, for example dispersants, silicate inhibitors and wetting agents. Corresponding water-comprising coolants and suitable additives are specified, for example, in documents JP 2006111728 A, JP 2004107620 A and JP 2007031502 A.

The prior art for loose abrasive wafer cutting is as follows: EP 1 757 419 A1 discloses a process for removing a workpiece, for example a wafer, by means of wire sawing, using a slurry applied to the wire and regulating or controlling the water content of at least a portion of the gaseous medium surrounding the slurry. EP 1 757 419 A1 also discloses using glycols as the carrier substance.

DE 199 83 092 B4 and U.S. Pat. No. 6,383,991 B1 disclose a cutting oil comprising a) a polyether compound and b) silica particles, and the use of this cutting oil composition for cutting an ingot using a wire saw, especially for cutting of silicon ingots.

EP 0 131 657 A1 and U.S. Pat. No. 4,828,735 disclose water-based lubricants based on polyethers. Chinese patent application CN 101205498 A likewise discloses aqueous cutting fluids, though no reduction in water absorption is reported. The specific compounds detailed are polyalkyleneoxy compounds etherified with alcohols having 1 to 4 carbon atoms. The document cited does not disclose that corresponding formulations have a particularly advantageous cooling or lubricating action.

EP 686 684 A1 discloses a cutting suspension consisting of an abrasive in aqueous phase, which comprises one or more water-soluble polymers as thickeners. US 2007/0010406 A1 discloses hydroxyl polyethers as additives for aqueous cutting fluids, one possible use for which is for production of silicon wafers.

The known cutting fluids for loose and fixed abrasive wafer cutting are generally water-based. However, the presence of water is disadvantageous because this can both cause corrosion and, for example, in the case of cutting of silicon wafers, can result in evolution of hydrogen through reaction of water and silicon. An additional problem which occurs here is that silicate and/or polysilicate is formed on the wafers, the wire and the machine.

The known water-soluble systems may also comprise water and attract water due to their hygroscopic properties, such that the same disadvantages can occur as in the case of aqueous systems.

It was an object of the invention to provide improved cooling and/or lubricating fluids which lead particularly to a decrease in water absorption and a decrease in the energy required in sawing. In addition, the corresponding cooling and/or lubricating fluids should ensure particularly high heat removal and particularly good lubrication of the wire saw, especially of a diamond wire saw.

These objects are achieved in accordance with the invention by the use of compounds of the formula I

R¹[O(EO)ₓ(AO)_{y}R²]_{z} (I)

with the following definitions:

R¹ is a z-valent alkyl radical having 1 to 10 carbon atoms,

R² is hydrogen and/or a monovalent alkyl radical having 1 to 10 carbon atoms,

EO is an ethyleneoxy radical,

AO is an alkyleneoxy radical having 3 to 10 carbon atoms,

x is a number from 1 to 8, especially 2 to 8,

y is a number from 0.5 to 6, especially 1 to 4,

z is a number from 1 to 6, especially 1 to 3,

for production of cooling and/or lubricating fluids for removal of material, especially for sawing of wafers with a wire saw, with reduced water absorption.

The invention further relates to cooling and/or lubricating fluid comprising at least one compound of the general formula I

R¹[O(EO)ₓ(AO)_{y}R²]_{z} (I)

with the following definitions:

R¹ is a z-valent alkyl radical having 1 to 10 carbon atoms,

R² is hydrogen and/or a monovalent alkyl radical having 1 to 10 carbon atoms,

EO is an ethyleneoxy radical,

AO is an alkyleneoxy radical having 3 to 10 carbon atoms,

x is a number from 1 to 6, especially 1 to 4,

y is a number from 0.5 to 6, especially 1 to 4,

z is a number from 1 to 6, especially 1 to 3,

wherein the cooling and/or lubricating fluid has a water content of less than 1% by weight.

The present invention further relates to the use of an inventive cooling and/or lubricating fluid for removal of material, especially for sawing of wafers with a wire saw, especially with a diamond wire saw, to a process for cutting wafers from an article with a wire saw, the article and/or the cut in the article being cooled and/or lubricated with an inventive cooling and/or lubricating fluid, and to wafers, especially silicon wafers, producible, especially produced, by the process according to the invention.

“Cooling and/or lubricating fluid” means, in accordance with the invention, that the corresponding fluids can be used in processes for removal of material as cooling fluid or as lubricating fluid or as a fluid which fulfils both functions, i.e. cooling and lubricating.

The inventive compounds correspond generally to the general formula I.

R¹ is generally a z-valent alkyl radical having 1 to 10 carbon atoms, preferably a z-valent alkyl radical having 1 to 8 carbon atoms, for example a z-valent alkyl radical having 1, 2, 3, 4, 5, 6, 7 or 8 carbon atoms, especially pentyl, for example 3-methyl-1-butanol, octyl, for example 2-ethylhexanol, methyl or butyl, especially 1-butyl.

The present invention therefore preferably relates to the inventive use, wherein, in the formula I,

R¹ is a z-valent alkyl radical having 1 to 6 carbon atoms, especially butyl.

“z-valent” in the context of the present invention means that the R¹ radical may be substituted at z sites by z alkylene oxide radicals of the formula I, i.e. R¹ originates from a z-hydric alcohol. z in formula I is generally 1 to 6, preferably 1 to 3, more preferably 1. According to the invention, therefore, preference is given to using mono- to trihydric alcohols R¹—(OH)_{z} as the basis for the inventive cooling and/or lubricating fluids.

R² is generally hydrogen and/or a monovalent alkyl radical having 1 to 10 carbon atoms, preferably hydrogen. In the inventive case that R¹ is a polyvalent radical, hydrogen and monovalent alkyl radical having 1 to 10 carbon atoms may be present alongside one another as R² radicals.

EO in the formula I is generally an ethyleneoxy radical, i.e. a radical which forms through ring-opening addition of ethylene oxide onto an alcohol, especially onto an alcohol of the formula R¹—OH or corresponding alkoxylates of these alcohols.

x in the formula I is generally a number from 1 to 8, especially 2 to 8, for example 1, 1.5, 2, 2.5, 3, 3.5, 4, 4.5, 5, 5.5, 6, 6.5, 7, 7.5 or 8. x may, in accordance with the invention, be a whole number or a fractional rational number. x describes, in accordance with the invention, the mean of the molar amount of ethylene oxide, based in each case on one mole of alcohol R¹—OH. Since, in accordance with the invention, a distribution of corresponding molecules with different amounts of ethylene oxide may be present, it is also possible to find fractional rational numbers for x. x is generally determined by processes known to those skilled in the art, for example gel permeation chromatography, HPLC and/or NMR spectroscopy.

For the inventive cooling and/or lubricating fluid, x is generally a number from 1 to 6, preferably 1 to 4, where x in this case too may be a whole number or a fractional rational number.

It is possible in accordance with the invention that, for the preparation of the polyglycols used in accordance with the invention, alcohols R¹—OH are used as the basis. It is also possible in accordance with the invention that alcohols R¹—OH which already with one, two, three or four equivalents of ethylene oxide, i.e. the corresponding mono-, di- or triglycols of the alcohols R¹—OH, are used. It is thus preferably also possible for mono- or diglycols of the alcohols Fe—OH, for example butyl monoglycol (BMG) or butyl diglycol (BDG), to serve as the starter alcohol.

AO in the formula I is generally an alkyleneoxy radical having 3 to 10 carbon atoms, preferably a propyleneoxy radical (PO), butyleneoxy radical (BuO) and/or pentyleneoxy radical (PeO), i.e. radicals which form through ring-opening addition of propylene oxide, butylene oxide and/or pentylene oxide onto an alcohol, especially onto an alcohol of the formula R¹—OH, or corresponding alkoxylates of these alcohols.

It is also possible in accordance with the invention that alcohols Fe—OH which have already been reacted with one, two, three or four equivalents of alkylene oxide (AO), i.e. the corresponding mono-, di- or trialkylene glycols of the alcohols R¹—OH, are used. It is thus preferably also possible to use alkyl alkylene glycols, for example methyl dipropylene glycol (MDP), as starter alcohols.

y in the formula I is generally a number from 0.5 to 6, especially 1 to 4, for example 0.5, 1, 1.5, 2, 2.5, 3, 3.5 or 4. y may, in accordance with the invention, be a whole number or a fractional rational number. y describes, in accordance with the invention, the mean of the molar amount of alkylene oxide, based in each case on one mole of alcohol R¹—OH. Since, in accordance with the invention, a distribution of corresponding molecules with different amounts of alkylene oxide may be present, it is also possible to find fractional rational numbers for y. y is generally determined by processes known to those skilled in the art, for example gel permeation chromatography, HPLC and/or NMR spectroscopy.

In the corresponding compounds of the formula I, the repeat (EO) and (AO) units may be present as a block or in random distribution. In a preferred embodiment, they are in random distribution. In the case of distribution as a block or randomly, it is first possible for one or more (EO) molecules or one or more (AO) molecules to be bonded to the alcohol R¹—OH.

In a preferred embodiment, the cooling and/or lubricating fluids consist of the compound of the formula I. The molecular weight of the compound of the formula I is preferably from 120 to 800 g/mol.

Very particularly preferred compounds of the formula I are selected from the group consisting of (3-methyl-1-butanol)-(PO)_{1.5}-(EO)_{5.0}, preferably prepared in blockwise mode, (2-ethylhexanol)-(PO)_{1.0}-(EO)_{5.0}, preferably prepared in blockwise mode, (methyl diethylene glycol)-(PeO)_{2.0}-(EO)_{6.0}, preferably prepared in blockwise mode, (1-butyl monoglycol)-(PO)_{3.0}-(EO)_{2.5}, preferably prepared in random mode, (1-butyl triglycol)-(PO)_{3.0} and mixtures thereof.

The general and preferred embodiments specified for the compounds of the formula I are independently relevant for the inventive use and for the inventive cooling and/or lubricating fluids per se.

The inventive cooling and/or lubricating fluids are notable more particularly in that they lubricate particularly efficiently in the case of use in the removal of material. This can be determined, for example, by the extent of attrition of a stainless steel cylinder in the case of use of the lubricating fluid. For this purpose, by tribological methods known to those skilled in the art, for example on a Reichert balance, the attrition characteristics are determined via the decrease in weight of a cylinder. The decrease in weight is reported in mg and is directly proportional to the lubricating action of the cooling and lubricating fluid used in accordance with the invention. The attrition is, in accordance with the invention, preferably less than 60 mg, preferably less than 50 mg, more preferably less than 45 mg, in each case measured as the decreasing weight of the stainless steel cylinder used, measured on a Reichert balance.

The present invention therefore preferably relates to the inventive use wherein the attrition is less than 60 mg, preferably less than 50 mg, more preferably less than 45 mg, measured in each case as the decrease in weight of the stainless steel cylinder used, measured on a Reichert balance.

The present invention therefore preferably also relates to the inventive cooling and/or lubricating fluid for which the abrasion is less than 60 mg, preferably less than 50 mg, more preferably less than 45 mg, measured in each case as the decrease in weight of the stainless steel cylinder used, measured on a Reichert balance.

According to the invention, the contact angle of the cooling and/or lubricating fluids on V2A steel at 25° C. after one second is preferably 10 to 40°, more preferably 10 to 35°.

The present invention therefore preferably relates to the inventive use wherein the contact angle of the cooling and/or lubricating fluids on V2A steel at 25° C. after one second is 10 to 40°, preferably 10 to 35°.

According to the invention, the viscosity of the cooling and/or lubricating fluids at 20° C. is preferably 36 to 120 mPas, more preferably 38 to 110 mPas.

The present invention therefore preferably relates to the inventive use wherein the viscosity of the cooling and/or lubricating fluids at 20° C. is preferably 15 to 120 mPas, more preferably 20 to 110 mPas, most preferably 38 to 110 mPas.

The inventive cooling and/or lubricating fluids may comprise not only one compound of the formula I but also mixtures of compounds of the formula I.

The general and preferred properties specified for the compounds of the general formula I and for the inventive use are also independently relevant to the inventive cooling and/or lubricating fluids per se.

The preparation of compounds of the formula I is known per se; see, for example, Nonionic Surfactants, edited by Martin J. Schick, Volume 2, Chapter 4 (Marcel Dekker, Inc., New York 1967).

The inventive coolants and/or lubricants can generally be used in all processes known to those skilled in the art for removal of material, especially for sawing of wafers with a wire saw. Preference is given to using the inventive cooling and/or lubricating fluids in what is called the loose abrasive wafer cutting process or the fixed abrasive wafer cutting process.

The loose abrasive wafer cutting process is known per se to those skilled in the art. The formulation comprises, as well as at least one compound of the formula I, abrasives for sawing, and optionally further additives defined in detail below.

It is possible to use the customary abrasives, especially abrasive and/or cutting grains, for example metal, metal or semimetal, carbide, nitride, oxide, boride or diamond grains. Particularly preferred cutting grains are carbide and boride grains, especially silicon carbide (SiC) grains. As a function of the materials and the wafers to be cut, the cutting grains preferably have an adjusted geometry; a preferred particle size is between 0.5 to 50 μm. The cutting grains may be present in heterodisperse or homodisperse form. The cutting grains are preferably present in the cooling and/or lubricating fluid in a concentration of 25 to 60% by weight, especially of 40 to 50% by weight.

Particular preference is given in accordance with the invention to using the cooling and/or lubricating fluid in a fixed abrasive wafer cutting process, especially using a diamond wire saw.

The present invention therefore preferably relates to the inventive use wherein the cooling and/or lubricating fluid is used in a fixed abrasive wafer cutting process, especially using a diamond wire saw.

According to the invention, the wafer to be produced comprises a semiconductive material, especially silicon, GaAs, CdTe or ceramic; the wafer more preferably consists of a semiconductive material, especially silicon, GaAs, CdTe or ceramic; particular preference is given to monocrystalline and polycrystalline silicon, very particular preference to monocrystalline silicon.

The present invention therefore preferably relates to the inventive use wherein the wafer comprises a semiconductive material, especially silicon, and especially consists of silicon.

These wafers are produced from cylindrical or cuboidal blocks of the corresponding semiconductive material by sawing with a wire saw. According to the invention, it is possible that these blocks are in mono- or polycrystalline form.

In the embodiment preferred in accordance with the invention, where the inventive cooling and lubricating fluids are used in a fixed abrasive wafer cutting process, it is possible in accordance with the invention to process mono- or polycrystalline blocks of semiconductive material. In this case, the cooling and/or lubricating fluid, in a preferred embodiment, apart from one or more compound(s) of the general formula I, does not comprise any further ingredients, which means that, in this embodiment, the inventive cooling and/or lubricating fluid consists of one or more compound(s) of the general formula I.

In general, the cooling and/or lubricating fluid used in accordance with the invention may comprise 1 to 50% by weight of water. In a preferred embodiment, the cooling and/or lubricating fluid used has a water content of less than 1% by weight, more preferably less than 0.5% by weight, most preferably less than 0.1% by weight.

The present invention therefore preferably relates to the inventive use wherein the cooling and/or lubricating fluid has a water content of less than 1% by weight, preferably less than 0.5% by weight, more preferably less than 0.1% by weight.

More preferably in accordance with the invention, the cooling and/or lubricating fluid used has a water content of less than 1% by weight, more preferably less than 0.5% by weight, most preferably less than 0.1% by weight, and is used in a fixed abrasive wafer cutting process, especially using a diamond wire saw.

The present invention therefore preferably relates to the inventive use wherein the cooling and/or lubricating fluid has a water content of less than 1% by weight, more preferably less than 0.5% by weight, most preferably less than 0.1% by weight, and is used in a fixed abrasive wafer cutting process, especially using a diamond wire saw.

In addition, the inventive cooling and/or lubricating fluids have reduced water absorption. The water absorption is, for example, 0 to 16% by weight, preferably 0.1 to 12% by weight, more preferably 0.1 to 11% by weight, determined in each case by difference weighing after storage at 38° C. and 78% relative air humidity for 7 h.

The inventive advantage that the cooling and/or lubricating fluid with the particularly low water contents mentioned is used is that no silicates can form from the silicon particle attritus as a result of the absence of water. The silicates complicate workup of the cooling and/or lubricating fluids used and therefore complicate the recycling of these fluids. In the absence of silicates, recycling of the silicon attritus in particular is made much easier.

The present invention therefore preferably relates to the inventive use wherein the cooling and/or lubricating fluids are worked up and/or recycled to remove the resultant attritus after the removal of the material, especially after the sawing of wafers with a wire saw.

A further advantage of the inventive cooling and/or lubricating fluids is that there is no need to add any additives intended, for example, to prevent silicate formation or bring about better lubrication. This fact too facilitates recycling of the fluids.

In a preferred embodiment of the process according to the invention, by means of the inventive cooling and/or lubricating fluids, polycrystalline wafers which may have an irregular crystal structure and inclusions of, for example, SiC are produced in the fixed abrasive wafer cutting process. One factor which makes this possible is the fact that the inventive cooling and/or lubricating fluids have much improved lubricity.

In addition, the inventive cooling and/or lubricating fluids have the advantage that they are readily water-soluble, which means that, after the sawing of the wafers, they can be cleaned easily by rinsing with water or aqueous solutions.

For the further embodiment which is possible in accordance with the invention, where the inventive cooling and/or lubricating fluids are used as aqueous formulations having a water content of, for example, 1 to 50% by weight, preference is given to adding additives to the formulations. These additives are known to those skilled in the art and are described hereinafter:

In one embodiment of the present invention, in addition to the compounds of the formula I, alkylene alcohols based on ethylene oxides, propylene oxides or copolymers formed from ethylene oxides and propylene oxides are present, preferably having a molecular weight of 200 to 800 g/mol.

Further possible additives for the inventive cooling and/or lubricating fluids are, for example,

monoalkylene, oligoalkylene or polyalkylene glycol,

wetting agent,

dispersant,

corrosion inhibitor,

complexing agent and/or

other additives such as scale inhibitors.

For example, at least one of the following additives is added in the following parts by weight per 100 parts by weight of the compound I:

alkylene glycols: 10 to 90, especially 20 to 60, parts by weight

wetting agent: 1 to 100, especially 10 to 40, parts by weight

dispersant: 0.1 to 20, especially 0.5 to 10, parts by weight

corrosion inhibitor: 0.1 to 10, especially 0.1 to 3, parts by weight

complexing agent: 0.1 to 10, especially 1 to 5, parts by weight

other additives: 0.05 to 10, especially 0.1 to 5, parts by weight

Particularly preferred additives are indicated below:

Wetting Agents

In addition to the compounds of the formula I to be used in accordance with the invention, it is possible to use further wetting agents, especially

(1) Poly(oxyalkylene) derivatives of
a) sorbitan esters, e.g. poly(oxyethylene)sorbitan monolaurate, poly(oxyethylene)sorbitan monooleate, poly(oxyethylene)sorbitan trioleate
b) fatty amines, e.g. tallow amino ethoxylates, soy amino ethoxylates,
c) castor oil, e.g. castor oil ethoxylates,
d) alkanolamides, e.g. coconut oil alkanolamide ethoxylates,
e) fatty acids, e.g. oleic acid ethoxylates, lauric acid ethoxylates, palmitic acid ethoxylates,
f) fatty alcohols,
g) linear alcohol ethoxylates, nonyiphenol ethoxylates, octylphenol ethoxylates

(2) Hydrophilic polydimethylsiloxanes
a) poly(dimethyl)siloxane substituted by at least one carbonyl end group, poly(dimethyl)siloxane copolymers,
c) poly(dimethylsiloxane)-b-poly(propylene oxide)-b-poly(ethylene oxide) copolymers,
d) polyquaternary (dimethylsiloxane) copolymers

(3) Fatty imidazolines

(4) Fatty acid esters of
a) phosphates,
b) sorbitans,
c) glycerol compounds, e.g. glyceryl monooleate, glyceryl dioleate, glyceryl trioleate, dilaurate,
e) sulphosuccinic acid,

(5) Quaternary compounds e.g.
quaternary ammonium methosuiphate.

Further suitable nonionic, cationic, anionic or amphoteric wetting agents are especially
alkoxylated C₄-C₂₂-alcohols such as fatty alcohol alkoxylates or oxo alcohol alkoxylates. These may be alkoxylated by ethylene oxide, propylene oxide and/or butylene oxide. All alkoxylated alcohols which have at least two molecules of one of the abovementioned alkylene oxides added on may be used as wetting agents. Possible compounds of this type are block polymers of ethylene oxide, propylene oxide and/or butylene oxide or addition products which comprise the abovementioned alkylene oxides distributed randomly or in blocks. The nonionic wetting agents generally comprise 2 to 50 mol, preferably 3 to 20 mol, of at least one alkylene oxide per mole of alcohol. The alcohols preferably have 10 to 18 carbon atoms. Depending on the type of alkoxylation catalyst used in the preparation, the method of preparation and the work-up, the alkoxylates have a broad or narrow alkylene oxide homologue distribution;
alkylphenol alkoxylates such as alkylphenol ethoxylates having C₆-C₁₄-alkyl chains and 5 to 30 alkylene oxide units;
alkyl polyglucosides having 8 to 22, preferably 10 to 18, carbon atoms in the alkyl chain and generally 1 to 20, preferably 1.1 to 5, glucoside units, sorbitan alkanoates, also alkoxylated;
N-alkylglucamides, fatty acid alkoxylates, fatty acid amine alkoxylates, fatty acid amide alkoxylates, fatty acid alkanolamide alkoxylates, alkoxylated, block copolymers of ethylene oxide; propylene oxide and/or butylene oxide, polyisobutene ethoxylates, polyisobutene-maleic anhydride derivatives, optionally alkoxylated monoglycerides, glyceryl monostearates, sorbitan esters and bisglycerides.

Particularly useful nonionic wetting agents are alkyl alkoxylates or mixtures of alkyl alkoxylates, as described, for example, in DE-A 102 43 363, DE-A 102 43 361, DE-A 102 43 360, DE-A 102 43 365, DE-A 102 43 366, DE-A 102 43 362 or DE-A 43 25 237. These are alkoxylation products obtained by reaction of alkanols with alkylene oxides in the presence of alkoxylation catalysts or mixtures of alkoxylation products. Particularly suitable starter alcohols are the Guerbet alcohols, especially ethylhexanol, propylheptanol and butyloctanol. Particular preference is given to propylheptanol. Preferred alkylene oxides are propylene oxide and ethylene oxide, with alkyl alkoxylates having a direct bond between a preferably short polypropylene oxide block and the starter alcohol, as described, for example, in DE-A 102 43 365, being particularly preferred because of their low residual alcohol content and their good biodegradability.

A preferred class of suitable nonionic wetting agents are the alcohol alkoxylates of the general formula (NI)

R¹-O—(CH₂—CHR⁵—O—)ᵣ(CH₂—CH₂—O—)ₙ(CH₂—CHR⁶—O—)ₛ(CH₂—CHR²—O—)ₘH (NI)

where

R¹ is an at least singly branched C₄₋₂₂-alkyl or -alkylphenol,

R² is C₃₋₄-alkyl,

R⁵ is C₁₋₄-alkyl,

R⁶ is methyl or ethyl,

n is a mean value of 1 to 50,

m is a mean value of 0 to 20, preferably 0.5 to 20,

r is a mean value of 0 to 50,

s is a mean value of 0 to 50,

where m is at least 0.5 when R⁵ is methyl or ethyl or r is 0.

Another possible mixture is one of 20 to 95% by weight, preferably 30 to 95% by weight, of at least one abovementioned alcohol alkoxylate and 5 to 80% by weight, preferably 5 to 70% by weight, of a corresponding alcohol alkoxylate in which R¹ is, however, an unbranched alkyl radical having the same number of carbon atoms.

Also useful are alcohol alkoxylates of the general formula (NII)

R³—O—(CH₂—CH₂—O)ₚ(CH₂—CHR⁴—O—)_{q}H (NII)

where

R³ is branched or unbranched C₄₋₂₂-alkyl or -alkylphenol,

R⁴ is C₃₋₄-alkyl,

p is a mean value of 1 to 50, preferably 4 to 15,

q is a mean value of 0.5 to 20, preferably 0.5 to 4, more preferably 0.5 to 2.

Another possible mixture is one of 5 to 95% by weight of at least one branched alcohol alkoxylate (NII) as described directly above and 5 to 95% by weight of a corresponding alcohol alkoxylate in which, however, an unbranched alkyl radical is present in place of a branched alkyl radical.

In the alcohol alkoxylates of the general formula (NI), R² is preferably propyl, especially n-propyl.

In the alcohol alkoxylates of the general formula (NII), n preferably has a mean value of 4 to 15, more preferably 6 to 12, especially 7 to 10.

m preferably has a mean value of 0.5 to 4, more preferably 0.5 to 2, especially 1 to 2.

The R¹ radical is preferably a C₈₋₁₅-, more preferably C₈₋₁₃- and especially C₈₋₁₂-alkyl radical which is at least singly branched. It is also possible for a plurality of branches to be present.

R⁵ is preferably methyl or ethyl, especially methyl.

R⁶ is preferably ethyl.

In the mixtures, compounds having unbranched and branched alcohol radicals R¹ are present. This is the case, for example, for oxo alcohols which have a proportion of linear alcohol chains and a proportion of branched alcohol chains. For example, a C_{13/15} oxo alcohol frequently has about 60% by weight of completely linear alcohol chains together with about 40% by weight of a-methyl-branched and C_{≧2}-branched alcohol chains.

In the alcohol alkoxylates of the general formula (NII), R³ is preferably a branched or unbranched C₈₋₁₅-alkyl radical, more preferably a branched or unbranched C₈₋₁₃-alkyl radical and especially a branched or unbranched C₈₋₁₂-alkyl radical. R⁴ is preferably propyl, especially n-propyl. p preferably has a mean value of 4 to 15, more preferably a mean value of 6 to 12 and especially a mean value of 7 to 10. q preferably has a mean value of 0.5 to 4, more preferably 0.5 to 2, especially 1 to 2.

In a manner analogous to the alcohol alkoxylates of the general formula (NI), the alcohol alkoxylates of the general formula (NII) may also be present as mixtures having unbranched and branched alcohol radicals.

Possible alcohol components on which the alcohol alkoxylates are based include not only pure alkanols but also homologous mixtures having a range of carbon atoms. Examples are C_{8/10}-alkanols, C_{10/12}-alkanols, C_{13/15}-alkanols, C_{12/15}-alkanols. Mixtures of a plurality of alkanols are also possible.

The above alkanol alkoxylates or mixtures according to the invention are preferably prepared by reacting alcohols of the general formula R¹—OH or R³—OH or mixtures of corresponding branched and unbranched alcohols optionally firstly with C₃₋₆-alkylene oxide, then with ethylene oxide and subsequently optionally with C₃₋₄-alkylene oxide and then with an appropriate C₅₋₆-alkylene oxide. The alkoxylations are preferably carried out in the presence of alkoxylation catalysts. Especially, basic catalysts such as potassium hydroxide are used here. The random distribution of the amounts of the alkylene oxides incorporated may be greatly restricted by means of specific alkoxylation catalysts such as modified bentonites or hydrotalcites as described, for example, in WO 95/04024, such that “narrow-range” alkoxylates are obtained.

In a particular embodiment of the present invention, the alkoxylates are alkoxylate mixtures comprising alkoxylates of the general formula (NIII)

C₅H₁₁CH(C₃H₇)CH₂O(B)ₚ(A)ₙ(B)ₘ(A)_{q}H (NIII)

where

A is ethyleneoxy,

the B radicals are each independently C₃₋₁₀-alkyleneoxy, preferably propyleneoxy, butyleneoxy, pentyleneoxy or mixtures thereof,

where groups A and B are present in the form of blocks in the order indicated,

p is 0 to 10,

n is >0 to 20,

m is >0 to 20,

q is >0 to 10,

p+n+m+q is at least 1,

where

70 to 99% by weight of alkoxylates A1 in which C₅H₁₁ is n-C₅H₁₁ and

1 to 30% by weight of alkoxylates A2 in which C₅H₁₁ is C₂H₅CH(CH₃)CH₂ and/or CH₃CH(CH₃)CH₂CH₂,

are present in the mixture.

In the general formula (NIII), p is 0 to 10, preferably 0 to 5, especially 0 to 3. If blocks (B)ₚ are present, p is preferably 0.1 to 10, more preferably 0.5 to 5, especially 1 to 3.

In the general formula (NIII), n is preferably in the range 0.25 to 10, especially 0.5 to 7, and m is preferably in the range 2 to 10, especially 3 to 6. B is preferably propyleneoxy and/or butyleneoxy, especially propyleneoxy in both positions.

q is preferably in the range 1 to 5, more preferably in the range 2 to 3.

The sum of p+n+m+q is at least 1, preferably 3 to 25, more preferably 5 to 15, especially 7 to 13.

Preference is given to 3 or 4 alkylene oxide blocks being present in the alkoxylates. In one embodiment, firstly ethyleneoxy units, then propylene oxide units and then ethyleneoxy units are adjoined to the alcohol radical. In a further embodiment, firstly propyleneoxy units, then ethyleneoxy units, then propyleneoxy units and finally ethyleneoxy units are adjoined to the alcohol radical. It is also possible for the other alkyleneoxy units indicated to be present in place of the propyleneoxy units.

p, n, m and q are each a value averaged over the alkoxylates. For this reason, p, n, m and q can also have noninteger values. The alkoxylation of alkanols generally gives a distribution of the degree of alkoxylation which can to a certain extent be set by use of different alkoxylation catalysts. The choice of appropriate amounts of the groups A and B enables the property spectrum of the alkoxylate mixtures according to the invention to be matched to practical requirements.

The alkoxylate mixtures are obtained by alkoxylation of the parent alcohols C₅H₁₁CH(C₃H₇)CH₂OH. The starting alcohols may be mixed from the individual components so to as give the ratio according to the invention. They may be prepared by aldol condensation of valeraldehyde and subsequent hydrogenation. Valeraldehyde and the corresponding isomers are prepared by hydroformylation of butene, as described, for example, in U.S. Pat. No. 4,287,370; Beilstein E IV 1, 32 68, Ullmanns Encyclopedia of Industrial Chemistry, 5th Edition, Volume A1, pages 323 and 328 The subsequent aldol condensation is described, for example, in U.S. Pat. No. 5,434,313 and Römpp, Chemie Lexikon, 9th Edition, keyword “Aldol-Addition”, page 91. The hydrogenation of the aldol condensation product follows general hydrogenation conditions.

In addition, 2-propylheptanol may be prepared by condensation of 1-pentanol (as mixture of the corresponding 1-methylbutanols) in the presence of KOH at elevated temperatures, see, for example, Marcel Guerbet, C. R. Acad Sci Paris 128, 511, 1002 (1899). Reference may also be made to Römpp, Chemie Lexikon, 9th Edition, Georg Thieme Verlag Stuttgart, and the references cited therein and also Tetrahedron, Vol. 23, pages 1723 to 1733.

In the general formula (NIII), the C₅H₁₁ radical may be n-C₅H₁₁, C₂H₅CH(CH₃)CH₂ or CH₃CH(CH₃)CH₂CH₂. The alkoxylates are mixtures in which
70 to 99% by weight, preferably 85 to 96% by weight, of alkoxylates A1 in which C₅H₁₁ is n-C₅H₁₁ are present and
1 to 30% by weight, preferably 4 to 15% by weight, of alkoxylates A2 in which C₅H₁₁ is C₂H₅CH(CH₃)CH₂ and/or CH₃CH(CH₃)CH₂CH₂ are present.

The C₃H₇ radical is preferably n-C₃H₇.

The alkoxylates may also be block isotridecanol alkoxylates of the general formula (NV)

R—O—(CₘH₂ₘO)ₓ—(CₙH₂ₙO)_{y}—H (NV)

where

R is an isotridecyl radical,

m is 2 and at the same time n is 3 or 4 or

m is 3 or 4 and at the same time n is 2 and

x and y are each independently 1 to 20,

where, in the case that m=2/n=3 or 4, the variable x is greater than or equal to y. These block isotridecanol alkoxylates are described, for example, in DE 196 21 843 A1.

Another suitable class of nonionic surfactants are end-capped alcohol alkoxylates, especially of alcohol alkoxylates mentioned above. In a particular embodiment, the end-capped alcohol alkoxylates are the end-capped alcohol alkoxylates corresponding to the alcohol alkoxylates of the general formulae (NI), (NII), (NIII) and (NV). The end cap may be produced, for example, by means of dialkyl sulphate, C₁₋₁₀-alkyl halides, C₁₋₁₀-phenyl halides, preferably chlorides, bromides, more preferably cyclohexyl chloride, cyclohexyl bromide, phenyl chloride or phenyl bromide.

Examples of end-capped alkoxylates are also described in DE-A 37 26 121, the entire relevant disclosure of which is incorporated by reference into the present invention. In a preferred embodiment, these alcohol alkoxylates have the general structure (NVI)

R¹—O—(CH₂—CHR^{II}—O)_{m′}(CH₂—CHR^{III}O)_{n′}R^{IV} (NVI)

where

R¹ is hydrogen or C₁-C₂₀-alkyl,

R^{II} and R^{III} are identical or different and are each independently hydrogen, methyl or ethyl,

R^{IV} is C₁-C₁₀-alkyl, preferably C₁-C₄-alkyl, or cyclohexyl or phenyl,

m′ and n′ are identical or different and are each greater than or equal to 0,

with the proviso that the sum of m′ and n′ is 3 to 300.

Another class of nonionic wetting agents is that of alkyl polyglucosides which preferably have 6 to 22, more preferably 10 to 18, carbon atoms in the alkyl chain. These compounds generally comprise 1 to 20, preferably 1.1 to 5, glucoside units.

Further possible nonionic wetting agents are the end-capped fatty acid amide alkoxylates of the general formula

R^{I}—CO—NH—(CH₂)_{y}—O-(A¹O)ₓ—R²

known from WO-A 95/11225, where

R^{I} is a C₅-C₂₁-alkyl or alkenyl radical,

R² is a C₁-C₄-alkyl group,

A¹ is C₂-C₄-alkylene,

y is 2 or 3 and

x is 1 to 6.

Examples of such compounds are the reaction products of n-butyl triglycolamine of the formula H₂N—(CH₂—CH₂—O)₃—C₄H₉ with methyl dodecanoate or the reaction products of ethyl tetraglycolamine of the formula H₂N—(CH₂—CH₂—O)₄—C₂H₅ with a commercial mixture of saturated C₈-C₁₈ methyl fatty acid esters.

Further suitable nonionic wetting agents are polyhydroxy or polyalkoxy fatty acid derivatives such as polyhydroxy fatty acid amides, N-alkoxy or N-aryloxy polyhydroxy fatty acid amides, fatty acid amide ethoxylates, especially end-capped fatty acid amide ethoxylates, and also fatty acid alkanolamide alkoxylates.

Further suitable nonionic wetting agents are block copolymers of ethylene oxide, propylene oxide and/or butylene oxide (Pluronic® and Tetronic® products from BASF SE and BASF Corp.). In a preferred embodiment, these copolymers are triblock copolymers having polyethylene/polypropylene/polyethylene blocks and a molecular weight of 4000 to 16 000, with the proportion by weight of the polyethylene blocks being 55 to 90%, based on the triblock copolymer. Particular preference is given to triblock copolymers having a molecular weight of more than 8000 and a polyethylene content of 60 to 85% by weight, based on the triblock copolymer. These preferred triblock copolymers are, more particularly, commercially available under the trade names Pluronic F127, Pluronic F108 and Pluronic F98, in each case from BASF Corp., and are described in WO 01/47472 A2, the entire relevant disclosure of which is incorporated by reference into the present invention.

In addition, preference is also given to using block copolymers of ethylene oxide, propylene oxide and/or butylene oxide capped at one or both ends. Capping at one end is achieved, for example, by using an alcohol, especially a C₁₋₂₂-alkyl alcohol, for example methanol, as starting compound for the reaction with an alkylene oxide. In addition, two-ended end capping, for example, may be produced by reacting the free block copolymer with dialkyl sulphate, C₁₋₁₀-alkyl halides, C₁₋₁₀-phenyl halides, preferably chlorides, bromides, more preferably cyclohexyl chloride, cyclohexyl bromide, phenyl chloride or phenyl bromide.

Individual nonionic wetting agents or a combination of different nonionic surfactants can also be used. It is possible to use nonionic wetting agents from only one class, especially only alkoxylated C₄-C₂₂-alcohols. However, as an alternative, wetting agent mixtures from various classes can also be used.

The concentration of nonionic wetting agent in the composition according to the invention can vary as a function of the leaching conditions, especially as a function of the material to be leached.

Suitable anionic wetting agents are alkanesulphonates such as C₈-C₂₄- and preferably C₁₀-C₁₈-alkanesulphonates, and also soaps such as the Na and K salts of saturated and/or unsaturated C₈-C₂₄-carboxylic acids.

Further suitable anionic wetting agents are linear C₈-C₂₀-alkylbenzenesulphonates (“LAS”), preferably linear C₉-C₁₃-alkylbenzenesulphonates and -alkyltoluene-sulphonates.

Dispersants/scale Inhibitors

It is additionally possible in accordance with the invention to make additional use of at least one dispersant, for example selected from the group consisting of salts of naphthalenesulphonic acids, condensation products of naphthalenesulphonic acids and formaldehyde and also polycarboxylates. Dispersants of this type are commercially available, for example, under the trade names Tamol®, Sokalan® and Nekal® from BASF SE and under the trade name Solsperse® from Lubrizol. These dispersants may also act as scale inhibitors (antideposition agents) since they disperse the calcium carbonate CaCO₃ formed in alkaline medium and thus prevent, for example, blockage of nozzles or formation of deposits in pipes. Independently of this, the composition according to the invention can additionally comprise at least one further scale inhibitor. Suitable scale inhibitors are described, for example, in WO 04/099092, which describes (meth)acrylic acid copolymers which comprise
(a) 50 to 80% by weight, preferably 50 to 75% by weight, more preferably 55 to 70% by weight, of a poly(meth)acrylic acid skeleton,
(b) 1 to 40% by weight, preferably 5 to 20% by weight, more preferably 7 to 15% by weight, of at least one unit which is selected from the group consisting of isobutene units, terelactone units and isopropanol units and is bound to the skeleton and/or incorporated into the skeleton and
(c) 5 to 50% by weight, preferably 5 to 40% by weight, more preferably 10 to 30% by weight, of amide units based on aminoalkylsulphonic acids,

where the total weight of the units in the (meth)acrylic acid copolymer is 100% by weight and all percentages by weight are based on the (meth)acrylic acid copolymer.

The (meth)acrylic acid copolymers provided in accordance with WO 04/099092 preferably have a weight average molecular weight of the polymer comprising sulphone groups of 1000 to 20 000 g/mol and can preferably be prepared by means of the following process steps:
(1) free-radical polymerization of (meth)acrylic acid in the presence of isopropanol and optionally water, resulting in a polymer I, and
(2) amidation of the polymer I from process step (1) by reaction with at least one aminoalkanesulphonic acid.

Further suitable scale inhibitors are, for example:
polycarboxylic acid monoamides obtainable by reaction of polymers comprising anhydride groups with compounds comprising amino groups (as described in DE 195 48 318),
vinyllactic acid and/or isopropenyllactic acid (as described in DE 197 195 16),
homopolymers of acrylic acid (as described in U.S. Pat. No. 3,756,257),
copolymers of acrylic acid and/or (meth)acrylic acid and vinyllactic acid and/or isopropenyllactic acid,
copolymers of styrene and vinyllactic acid,
copolymers of maleic acid and acrylic acid,
water-soluble or water-dispersible graft polymers obtainable by free-radically initiated graft polymerization of
   (I) at least one monoethylenically unsaturated monomer,
   (II) polymers having a molar mass of 200 to 5000 g/mol of monoethylenically unsaturated dicarboxylic acids or anhydrides thereof,
   (III) where 5 to 2000 parts by weight of (I) are used per 100 parts by weight of the graft base (II) (DE 195 03 546),
optionally hydrolysed polymaleic anhydrides and salts thereof (as described in U.S. Pat. No. 3,810,834, GB-A-1 454 657 and EP-A-0 261 589),
iminodisuccinates (as described in DE 101 02 209),
formulations comprising complexing agents such as ethylenediaminetetraacetic acid (EDTA) and/or diethylenetriaminepentaacetic acid (DTPA) (as described in U.S. Pat. No. 5,366,016),
phosphonates,
polyacrylates,
polyaspartic acids or polyaspartic acids which have been modified as described in DE-A-44 34 463,
polyaspartimides,
polymers comprising hydroxamic acid, hydroxamic ether and/or hydrazide groups (as described in DE 44 27 630),
optionally hydrolysed polymers of maleimide (as described in DE 43 42 930),
naphthylamine polycarboxylates (as described in EP 0 538 969),
oxaalkanepolyphosphonic acids (as described in EP 330 075),
polyhydroxyalkaneaminobismethylenephosphonic acids (as described in DE 40 16 753) and
oxidized polyglucosanes (as described in DE 43 30 339).

Particularly preferred dispersants are polyacrylic acid, for example the Sokalan® products from BASF SE, and polyaspartic acids, especially β-polyaspartic acids, having a molecular weight of 2000 to 10 000 g/mol. Preferred polymeric compounds comprising carboxylic acid groups are the acrylic acid homopolymers indicated in EP 2 083 067 A1. These preferably have a number average molecular weight in the range 1000 to 50,000, more preferably 1500 to 20,000. Homopolymers of acrylic acid which are particularly suitable as polymeric compounds comprising carboxylic acid groups are the Sokalan® PA products from BASF SE.

Further suitable polymeric compounds comprising carboxylic acid groups are oligomaleic acids as described, for example, in EP-A 451 508 and EP-A 396 303.

Other compounds which are preferred as polymeric compounds comprising carboxylic acid groups are copolymers comprising at least one unsaturated monocarboxylic or dicarboxylic acid or a dicarboxylic anhydride or a salt thereof as monomer A) and at least one comonomer B) in copolymerized form. The monomer A) is preferably selected from C₃-C₁₀-monocarboxylic acids, salts of C₃-C₁₀-monocarboxylic acids, C₄-C₈-dicarboxylic acids, anhydrides of C₄-C₈-dicarboxylic acids, salts of C₄-C₈-dicarboxylic acids and mixtures thereof. Monomers A) in salt form are preferably used in the form of their water-soluble salts, especially the alkali metal salts such as potassium and especially sodium salts or the ammonium salts. The monomers A) can in each case be entirely or partly present in anhydride form. Of course, it is also possible to use mixtures of monomers A).

The monomers (A) are preferably selected from acrylic acid, methacrylic acid, crotonic acid, vinylacetic acid, maleic acid, maleic anhydride, fumaric acid, citraconic acid, citraconic anhydride, itaconic acid and mixtures thereof. Particularly preferred monomers A) are acrylic acid, methacrylic acid, maleic acid, maleic anhydride and mixtures thereof. These copolymers preferably comprise at least one monomer A) in an amount of 5 to 95% by weight, more preferably 20 to 80% by weight, especially 30 to 70% by weight, based on the total weight of the monomers used for the polymerization, in copolymerized form.

Corrosion Inhibitors

The agents which act as corrosion inhibitors are those specified, for example, in WO 2008/071582 A1, for example carboxylic acids. These may be linear or branched. Mixtures of various carboxylic acids may be particularly preferred. Caprylic acid, ethylhexanoic acid, isononanoic acid and isodecanoic acid are particularly preferred carboxylic acids. Since anticorrosion emulsions are frequently neutral to weakly alkaline, it may be advantageous to use the carboxylic acids at least partly in neutralized form, i.e. in salt form. Sodium hydroxide and/or potassium hydroxide and also alkanolamines are particularly suitable for neutralization. Particular preference is given to using monoalkanolamines and/or trialkanolamines. The use of dialkanolamines is less preferred because of the risk of formation of nitrosamines. Dialkanolamines may be used equally well either alone or together with monoalkanolamines and/or trialkanolamines for neutralization.

Suitable corrosion inhibitors are especially:

aliphatic carboxamides having 14 to 36 carbon atoms, for example myristamide, palmitamide and oleamide; alkenylsuccinamides having 6 to 36 carbon atoms, for example octenylsuccinamide, dodecenylsuccinamide; mercatobenzothiazoles.

Particularly preferred corrosion inhibitors are alkylene oxide adducts with aliphatic amines, especially triethanolamine and ethylenediamine adducts with 2 to 8 mol% of propylene oxide.

Complexing Agents

Complexing agents are compounds which bind cations. Typical examples are: EDTA (N,N,N′,N′-ethylenediaminetetraacetic acid), NTA (N,N,N-nitrilotriacetic acid), MGDA (2-methylglycine-N,N-diacetic acid), GLDA (glutamic acid diacetate), ASDA (aspartic acid diacetate), IDS (iminodisuccinate), HEIDA (hydroxyethylimine diacetate), EDDS (ethylenediamine disuccinate), citric acid, oxodisuccinic acid and butanetetracarboxylic acid and completely or partially neutralized alkali metal or ammonium salts thereof.

Other Additives

Particularly suitable additives are scale inhibitors for silicates. These are preferably alkoxylation products of amines, more preferably alkylenediamines, as sold by BASF Corp. and BASF SE under the Tetronic® trade name. Tetronic® 90R4 from BASF Corp. has been found to be very particularly suitable.

Further suitable additives are, for example, adhesion promoters. Suitable adhesion promoters are, for example, the amphiphilic water-soluble alkoxylated polyalkyleneimines of the general formula A1 indicated in WO 2006/108856 A2

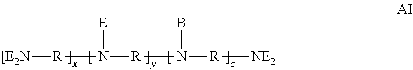

where the variables are each defined as follows:

the R radicals are identical or different, linear or branched C2-C6-alkylene radicals;

B is a branch;

E is an alkyleneoxy unit of the formula

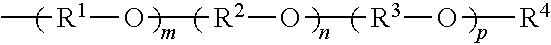

R1 is 1,2-propylene, 1,2-butylene and/or 1,2-isobutylene;

R2 is ethylene;

R3 is 1,2-propylene;

R4 are identical or different radicals: hydrogen; C1-C4-alkyl;

x, y, z are each 2 to 150, where the sum x+y+z is the number of alkyleneimine units and corresponds to a mean molecular weight Mw of the polyalkyleneimine before the alkoxylation of 300 to 10 000;

m is a rational number from 0 to 2;

n is a rational number from 6 to 18;

p is a rational number from 3 to 12, where 0.8≦n/p≦1.0(x+y+z)1/2.

The present invention also relates to a cooling and/or lubricating fluid comprising at least one compound of the general formula I

R¹[O(EO)ₓ(AO)_{y}R²]_{z} (I)

with the following definitions:

R¹ is a z-valent alkyl radical having 1 to 10 carbon atoms,

R² is hydrogen and/or a monovalent alkyl radical having 1 to 10 carbon atoms,

EO is an ethyleneoxy radical,

AO is an alkyleneoxy radical having 3 to 10 carbon atoms,

x is a number from 1 to 8, especially 2 to 8,

y is a number from 0.5 to 6, especially 1 to 4,

z is a number from 1 to 6, especially 1 to 3,

wherein the cooling and/or lubricating fluid has a water content of less than 1% by weight.

With regard to the inventive cooling and/or lubricating fluids, the statements made above with regard to the inventive use apply correspondingly.

The present invention preferably relates to the inventive cooling and/or lubricating fluid where R¹ is butyl.

The present invention also relates to the use of an inventive cooling and/or lubricating fluid for removal of material, especially for sawing of wafers with a wire saw, especially with a diamond wire saw. For this purpose, the statements made for the loose abrasive wafer cutting process and the fixed abrasive wafer cutting process apply correspondingly.

The present invention also relates to a process for cutting wafers from an article, especially a block, ingot or cylinder of a semiconductive material, for example silicon, GaAs, CdTe and ceramics, especially from silicon blocks, silicon ingots or silicon cylinders with a wire saw, wherein the article and/or the cut in the article is cooled and/or lubricated with an inventive cooling and/or lubricating fluid as defined above.

The present invention also relates to a wafer, especially silicon wafer, producible, especially produced, by the process according to the invention. These wafers produced in accordance with the invention are notable, due to the process according to the invention for production thereof, in that they have fewer hairline cracks than wafers produced by prior art processes. This results in a lower risk of fracture. In addition, the wafers, due to the production process according to the invention, have a more homogeneous surface with fewer grooves than wafers produced according to the prior art.

The inventive cooling and/or lubricating fluid and the process according to the invention for cutting are especially suitable for the sawing of ingots, blocks or cylinders of mono- or polycrystalline single silicon crystals or silicon polycrystals, GaAs, CdTe and other semiconductors and ceramics.

The inventive cooling and/or lubricating fluid can preferably be used as an anhydrous formulation without further additives, and is therefore outstandingly suitable for processing by chemical wet workup, for example according to WO 02/40407 A1 and EP 1 390 184 A1.

### EXAMPLES

General Preparation Method for Polyethers

An anhydrous, dry 1 l pressure reactor is initially charged in each case with 1 to 2 mol of the starter alcohol, and 0.2% by weight (based on end product) of KOH is added, and the reactor is purged with nitrogen. The closed reactor is then heated to 130° C. over the course of 30 min, and nitrogen is used to establish a gauge pressure of 1 bar. Subsequently, the molar amounts of propylene oxide or pentene oxide (referred to hereinafter as PO and PeO respectively) and ethylene oxide (referred to hereinafter as EO) specified in Table 1 are metered in parallel (random mode) or successively (blockwise mode) while stirring.

In blockwise mode, after PO or PeO addition and attainment of constant pressure, and prior to EO addition, the mixture is stirred at 130° C. for at least 0.5 h and the pressure is adjusted to 1 bar. During the reaction, the vessel is thermostated at 130° C. On attainment of constant pressure, stirring is continued for another approx. 0.5 h. After the reaction has ended, the mixture is cooled to 80° C., the reactor is decompressed and purged with nitrogen, the amount of glacial acetic acid calculated for neutralization of the KOH is added, and the mixture is stirred for a further 0.5 h.

The OH number is determined to DIN 51562, the residual alcohol by means of gas chromatography, and the APHA colour number to EN 1557 (at 23° C.).

TABLE 1
Examples and analysis

| | | | Residual | |
|---|---|---|---|---|
| | | OH | alcohol | Colour |
| Product | Chem. composition | number | [% by wt.] | number |
| C1 | (3-Methyl-1-butanol) + 1.5 PO + | 161.3 | 0.15 | 50 |
| | 5.0 EO, blockwise mode | | | |
| C2 | (2-Ethyl-hexanol) + 1.0 PO + | 138.0 | 0.2 | 35 |
| | 5.0 EO, blockwise mode | | | |
| C3 | (Methyldiethylene glycol) + 2.0 | 120.7 | 0.25 | 40 |
| | PeO + 6.0 EO, random mode | | | |
| C4 | (1-Butylmonoglycol) + 3.0PO + | 140.4 | <0.1 | 20 |
| | 2.5 EO, random mode | | | |
| C5 | (1-Butyltriglycol) + 3.0 PO | 128.9 | <0.1 | 20 |
| C6 | Methanol + 3.0 PO | 271.7 | <0.1 | 15 |
| C7 | Sanyo Histad TDM-100 | n. d. | n. d. | n. d. |
| | (Sanyo Chemical Industries, | | | |
| | Japan) | | | |

Examples C1 to C5 are inventive examples; Examples C6 and C7 are comparative examples; n.d. means not determined.

Properties

The properties of the inventive cooling and/or lubricating fluids C1 to C5 are summarized in Table 2. For comparison, 2 noninventive examples are listed (C6 and C7), which are used industrially as cutting fluids (market standard). C7 comprises 80% by weight of propylene glycol, 18% by weight of water and 2% by weight of unspecified or unanalysed additives.

The following properties were determined:

Water Absorption

The water absorption of the cooling and/or lubricating fluids, after storage thereof in a Heraeus BBD 6220 CO₂ incubator, is determined at 38° C. and 78% relative air humidity after a period of 7 h. For storage, 1 g of cutting fluid is used in each case in Petri dishes of internal diameter 60 mm. The mean of a double determination is found in each case. The water absorption is reported in percent by weight increase based on starting weight in each case.

Viscosity

The viscosity of the cutting fluids is determined at 20° C. with a Brookfield LVDV-III Ultra apparatus (V-73 spindle). The viscosity is reported in mPas.

Contact Angle

The contact angle of the cutting fluids is determined at 25° C. one second after droplet application to a plate of V2A steel, the surface of which is rinsed with water and acetone and then dried under air. For determination, a video-supported high-speed contact angle measuring instrument from Dataphysics Instruments GmbH, Filderstadt is used. The unit of the contact angle is reported in degrees [°].

Attritus

The attrition characteristics are determined on an MDD2 balance from Hermann Reichert Maschinenbau, Heidenhof Backnang, at a load of 300 N and a distance of 110 m in one minute on a needle bearing ZRO.12×18 stainless steel cylinder for roller bearings. The cylinders are purchased from: Timken Company, Canton, Ohio, USA. A double determination is conducted in each case and the mean of the weight decrease of the cylinder is determined. The weight decrease is reported in mg.

TABLE 2

| | H₂O absorption | Viscosity | Contact | |
|---|---|---|---|---|
| | after 7 h | at 20° C. | angle | Attritus |
| Product | [% by wt.] | [mPas] | [°] | [mg] |
| C1 | 10.2 | 43 | 17 | 43 |
| C2 | 9.7 | 89 | 23 | 42 |
| C3 | 10.3 | 100 | 30 | 32 |
| C4 | 9.6 | 39 | 15 | 28 |
| C5 | 9.4 | 38 | 24 | 33 |
| C6 | 20.5 | 12 | 8 | 72 |
| C7 | itself comprises | 35 | 36 | 83 |
| | 18% by weight of water | | | |

1. Use of compounds of the general formula I
R¹[O(EO)ₓ(AO)_{y}R²]_{z} (I)
with the following definitions:
R¹ is a z-valent alkyl radical having 1 to 10 carbon atoms,
R² is hydrogen and/or a monovalent alkyl radical having 1 to 10 carbon atoms,
EO is an ethyleneoxy radical,
AO is an alkyleneoxy radical having 3 to 10 carbon atoms,
x is a number from 1 to 8, especially 2 to 8,
y is a number from 0.5 to 6, especially 1 to 4,
z is a number from 1 to 6, especially 1 to 3,
for production of cooling and/or lubricating fluids for removal of material, especially for sawing of wafers with a wire saw, with reduced water absorption.

2. Use according to claim 1, characterized in that, in the formula I,
R¹ is a z-valent alkyl radical having 1 to 6 carbon atoms, especially butyl.

3. Use according to claim 1 or 2, characterized in that the contact angle of the cooling and/or lubricating fluids on V2A steel at 25° C. after one second is 10 to 40°, preferably 10 to 35°.

4. Use according to claims 1 to 3, characterized in that the viscosity of the cooling and/or lubricating fluids at 20° C. is preferably 15 to 120 mPas, more preferably 20 to 110 mPas.

5. Use according to any of claims 1 to 4, characterized in that the wafer comprises a semi-conductive material, especially silicon, and especially consists of silicon.

6. Use according to any of claims 1 to 5, characterized in that the cooling and/or lubricating fluid is used in a fixed abrasive wafer cutting process, especially using a diamond wire saw.

7. Use according to any of claims 1 to 6, characterized in that the coolant and/or lubricant has a water content of less than 1% by weight.

8. Use according to any of claims 1 to 7, characterized in that the coolant and/or lubricant is worked up and/or recycled after the removal of the material, especially after the sawing of wafers with a wire saw, for removal of the resultant attritus.

9. Use according to any of claims 1 to 8, characterized in that the attritus is less than 60 mg, measured as the decrease in weight of the stainless steel cylinder used, measured on a Reichert balance.

10. Cooling and/or lubricating fluid comprising at least one compound of the general formula I
R¹[O(EO)ₓ(AO)_{y}R²]_{z} (I)
with the following definitions:
R¹ is a z-valent alkyl radical having 1 to 10 carbon atoms,
R² is hydrogen and/or a monovalent alkyl radical having 1 to 10 carbon atoms,
EO is an ethyleneoxy radical,
AO is an alkyleneoxy radical having 3 to 10 carbon atoms,
x is a number from 1 to 6, especially 1 to 4,
y is a number from 0.5 to 6, especially 1 to 4,
z is a number from 1 to 6, especially 1 to 3,
characterized in that the cooling and/or lubricating fluid has a water content of less than 1% by weight.

11. Cooling and/or lubricating fluid according to claim 10, characterized in that R¹ is butyl.

12. Use of a cooling and/or lubricating fluid according to claim 10 for removal of material, especially for sawing of wafers with a wire saw, especially with a diamond wire saw.

13. Process for cutting wafers from an article with a wire saw, characterized in that the article and/or the cut in the article is cooled and/or lubricated with a cooling and/or lubricating fluid as defined in claim 1 or according to claim 10 or 11.

14. Wafer, especially silicon wafer, producible, especially produced, by the process to claim 13.
